(19) United States
(12) Patent Application Publication
(10) Pub. No.: US 2010/0008020 A1
(43) Pub. Date: Jan. 14, 2010

(54) ELECTRODE DEVICE

(76) Inventor: Adrian Schneuwly, Schmitten (CH)

Correspondence Address: Maxwell Technologies, Inc. (OPLF), 9244 Balboa Avenue, San Diego, CA, 92123, US

(21) Appl. No.: 12/170,373

(22) Filed: Jul. 9, 2008

(51) Int. Cl. H01G 9/016

(52) U.S. Cl. 361/502; 29/25.03

(57) ABSTRACT

Electrodes, electrode devices, and methods of producing electrodes and electrode devices are disclosed. An exemplary method may comprise positioning a current collector between a first electrode film and a second electrode film. The method may also comprise coupling the first electrode film and the second electrode film through a plurality of openings formed in the current collector to secure the first electrode film and the second electrode film to the current collector without using an adhesive. The method may be used to produce electrodes and electrode devices including, but not limited to, double-layer and other compound capacitor devices such as ultra-capacitors and super-capacitors.

### BACKGROUND

The present invention generally relates to electrode devices used in energy storage devices.

Electrode devices are widely used to store electrical energy, including primary (non-rechargeable) battery cells, secondary (rechargeable) battery cells, fuel cells, and capacitors. Important characteristics of these electrode devices include energy density, power density, maximum charging rate, internal leakage current, equivalent series resistance (ESR), and/or durability (i.e., the ability to withstand multiple charge-discharge cycles). For a number of reasons, compound capacitors, also known as “super-capacitors” and “ultra-capacitors,” are gaining popularity in many energy storage applications. The reasons include availability of compound capacitors with high power densities (in both charge and discharge modes), and with energy densities approaching those of conventional rechargeable cells.

Compound capacitors typically use electrodes immersed in an electrolyte (an electrolytic solution), as their energy storage element. As such, a porous separator immersed in and impregnated with the electrolyte may ensure that the electrodes do not come in contact with each other, preventing electronic current flow directly between the electrodes. At the same time, the porous separator allows ionic currents to flow through the electrolyte between the electrodes in both directions. As discussed below, compounds of charges are formed at the interfaces between the solid electrodes and the electrolyte.

When electric potential is applied between a pair of electrodes of a compound capacitor, ions that exist within the electrolyte are attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. In fact, the charge separation layers behave essentially as electrostatic capacitors. Electrostatic energy can also be stored in the compound capacitors through orientation and alignment of molecules of the electrolytic solution under influence of the electric field induced by the potential. This mode of energy storage, however, is secondary.

In comparison to conventional capacitors, compound capacitors have high capacitance in relation to their volume and weight. There are two main reasons for these volumetric and weight efficiencies. First, the charge separation layers are very narrow. Their widths are typically on the order of nanometers. Second, the electrodes can be made from a porous material, having very large effective surface area per unit volume. Because capacitance is directly proportional to the electrode area and inversely proportional to the widths of the charge separation layers, the combined effect of the large effective surface area and narrow charge separation layers is capacitance that is very high in comparison to that of conventional capacitors of similar size and weight. High capacitance of compound capacitors allows the capacitors to receive, store, and release a large amount of electrical energy.

Another important performance parameter of a capacitor is its internal resistance. Frequency response of a capacitor depends on the characteristic time constant of the capacitor, which is essentially a product of the capacitance and the internal resistance, or RC. To put it differently, internal resistance limits both charge and discharge rates of a capacitor, because the resistance limits the current that flows into or out of the capacitor. Maximizing the charge and discharge rates is important in many applications. In automotive applications, for example, a capacitor that is used as the energy storage element that powers a vehicle's engine has to be able to provide high instantaneous power during acceleration, and to receive bursts of power produced by regenerative braking. In internal combustion-powered vehicles, the capacitor periodically powers a vehicle's starter, also requiring high power in relation to the size of the capacitor.

The internal resistance also creates heat during both charge and discharge cycles. Heat causes mechanical stresses and speeds up various chemical reactions, thereby accelerating capacitor aging. It is therefore desirable to reduce internal resistance of capacitors. Moreover, the energy converted into heat is lost, decreasing the efficiency of the capacitor.

Active materials used for electrode construction (e.g., activated carbon) usually have rather limited specific conductance. Thus, a large contact area may be desired to minimize the contact resistance between the electrode and its terminal. The active material may also be too brittle or otherwise unsuitable for directly connecting to terminals. Additionally, the material may have relatively low tensile strength, needing mechanical support in some applications. For these reasons, electrodes incorporate current collectors.

A current collector is typically a sheet of conductive material on which the active electrode is disposed, either directly or over one or more intermediate layers. Often, aluminum foil is used as the current collector material of a composite electrode. In one electrode fabrication process, a film that includes activated carbon powder (i.e., the active electrode) is produced, and then attached to a thin aluminum foil using an adhesive. The use of the adhesive improves bonding of the active electrode to the current collector. Unfortunately, this process also has a number of disadvantages.

The adhesive increases the cost of materials consumed in the process of electrode fabrication; some adhesives are quite expensive. In addition, two steps are added to the fabrication process. The adhesive must be applied onto the current collector foil, or onto the active electrode film. The adhesive must also be allowed to dry and cure. These extra steps increase the cost of the final product. The adhesive may deteriorate with time, contributing to an increase in the internal resistance of the electrode. In some compound capacitors, for example, the electrolyte reacts chemically with the adhesive, causing the adhesive to weaken and the bond created by the adhesive to fail. Furthermore, adhesive use reduces the energy storage efficiency of the electrode, because the adhesive penetrates into the pores of the active electrode, decreasing the total surface active area of the electrode. Therefore, it would be preferable to reduce or eliminate the use of adhesives in compound electrodes.

### SUMMARY

A need thus exists for fabricating compound electrodes substantially without the use of adhesives at the interface between the active electrode and the current collector. A further need exists for electrodes fabricated without the use of adhesives at this interface. Still another need exists for energy storage devices with electrodes without adhesive on the interfaces between the active layers and the current collectors. Still further needs exist for methods and materials for making such electrodes and electrical devices, including compound capacitors, using such electrode materials.

Various implementations hereof are directed to electrodes, electrode devices, and methods of manufacturing/fabricating the same that may be directed to or may satisfy one or more of the above needs.

An exemplary electrode comprises a first electrode film and a second electrode film. A current collector is sandwiched between the first electrode film and the second electrode film during a manufacture process. The current collector has a plurality of openings formed there through. A bond is formed at an interface between the first electrode film and the second electrode film through the plurality of openings formed in the current collector after the manufacture process, the bond securing the first electrode film and the second electrode film to the current collector substantially without using an adhesive.

Exemplary electrodes may be used to manufacture compound capacitor devices, such as, e.g., ultra-capacitors and super-capacitors. An exemplary compound capacitor device comprises a porous current collector sandwiched between two binder materials. An interface couples the two binder materials to one another and to the porous current collector substantially without an adhesive.

An exemplary method of producing an electrode material comprises positioning a current collector between a first electrode film and a second electrode film, and coupling the first electrode film and the second electrode film through a plurality of openings formed in the current collector to secure the first electrode film and the second electrode film to the current collector substantially without using an adhesive.

In exemplary embodiments, the first electrode film and second electrode film includes at least carbon. Also in exemplary embodiments, the first electrode film and the second electrode film may be electrically coupled at least in part by a mechanical interaction (e.g., mechanical meshing) and/or a chemical reaction between the first electrode film and the second electrode film.

The manufacturing process reduces or altogether eliminates the need for solvent based adhesion means, and accordingly implements a substantially or completely dry process. The resulting electrodes and electrode devices have improved interface stability and therefore reduced ESR. The electrodes and electrode devices also experience no (or significantly reduced) delamination and crack formation during use over time, and therefore have improved longevity. In addition, the plurality of openings formed in the current collector also provides improved drying and/or electrolyte impregnation of the electrodes and electrode devices. The openings reduce the barrier between the electrode layers by allowing drying and/or electrolyte impregnation through the openings in the current collector.

### BRIEF DESCRIPTION OF THE DRAWINGS

FIG. 1 is a partially-exploded cross-sectional perspective view of an exemplary electrode.

FIG. 2a and 2b are top views of alternative configurations of exemplary current collectors which may be implemented for the electrode.

FIG. 3 is a side view of the exemplary electrode taken along lines 3-3 in FIG. 1 showing an exemplary interface that may be formed through the openings of the current collector between the electrode materials.

FIG. 4a and 4b are side views illustrating a rolling process for manufacturing an exemplary electrode device from an electrode.

FIG. 5 is a flowchart illustrating exemplary process steps for producing an exemplary electrode.

### DETAILED DESCRIPTION

In this document, the words “implementation” and “variant” may be used to refer to a particular apparatus, process, or article of manufacture, and not necessarily always to one and the same apparatus, process, or article of manufacture. Thus, “one implementation” (or a similar expression) used in one place or context can refer to one particular apparatus, process, or article of manufacture; and, the same or a similar expression in a different place can refer either to the same or to a different apparatus, process, or article of manufacture. Similarly, “some implementations,” “certain implementations,” or similar expressions used in one place or context may refer to one or more particular apparatuses, processes, or articles of manufacture; the same or similar expressions in a different place or context may refer to the same or a different apparatus, process, or article of manufacture. The expression “alternative implementation” and similar phrases are used to indicate one of a number of different possible implementations. The number of possible implementations is not necessarily limited to two or any other quantity. Characterization of an implementation as “an exemplar” or “exemplary” means that the implementation is used as an example. Such characterization does not necessarily mean that the implementation is a preferred implementation; the implementation may but need not be a currently preferred implementation.

The meaning of the word “film” is similar to the meaning of the words “layer” and “sheet”; the word “film” does not necessarily imply a particular thickness or thinness of the material. The references to “binder” within this document are intended to convey the meaning of polymers, co-polymers, and similar ultra-high molecular weight substances capable of providing a binding for a material (e.g., activated carbon) therein. Such substances are often employed as binder for promoting cohesion in loosely-assembled particulate materials, i.e., active filler materials that perform some useful function in a particular application.

The words “calender,” “nip,” “laminator,” and similar expressions mean a device adapted for pressing and compressing. Pressing may be, but is not necessarily, performed using rollers. When used as verbs, “calender” and “laminate” mean processing in a press, which may, but need not, include rollers. Mixing or blending as used herein may mean processing which involves bringing together component elements into a mixture. High shear or high impact forces may be, but are not necessarily, used for such mixing. Example equipment that can be used to prepare/mix the various materials described herein may include, in non-limiting fashion: a ball mill, an electromagnetic ball mill, a disk mill, a pin mill, a high-energy impact mill, a fluid energy impact mill, an opposing nozzle jet mill, a fluidized bed jet mill, a hammer mill, a fritz mill, a Warring blender, a roll mill, a mechanofusion processor (e.g., a Hosokawa AMS), or an impact mill.

Other and further definitions and clarifications of definitions may be found throughout this document. The definitions are intended to assist in understanding this disclosure and the appended claims, but the scope and spirit of the invention should not be construed as strictly limited to the definitions, or to the particular examples described in this specification.

Reference will now be made in detail to several embodiments of the invention that are illustrated in the accompanying drawings. The same reference numerals are used in the drawings and the description to refer to the same or substantially the same parts or operations. The drawings are in simplified form and not to precise scale. For purposes of convenience and clarity only, directional terms, such as top, bottom, left, right, up, down, over, above, below, beneath, rear, and front may be used with respect to the accompanying drawings. These and similar directional terms, should not be construed to limit the scope of the invention.

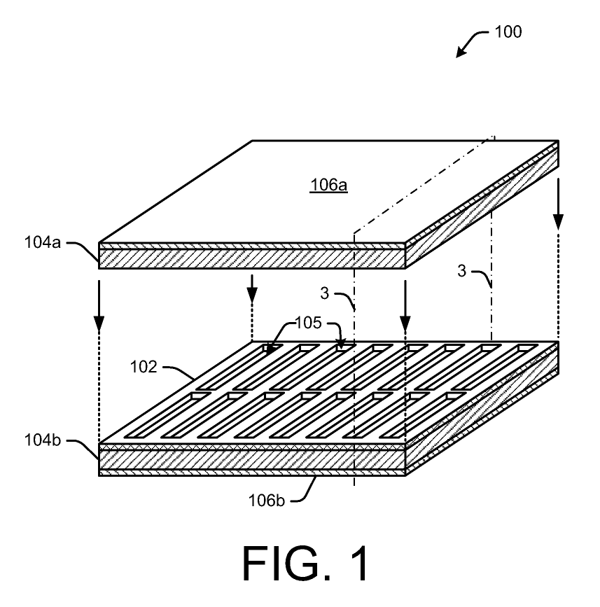

FIG. 1 is a partially-exploded cross-sectional perspective view of an exemplary electrode 100 in accordance with the present invention. The electrode 100 includes a current collector 102, and a film of active electrode film 104a-b disposed on each side of the current collector 102. Optionally, a noncurrent collector 106a-b may be applied on one or both of the outer surfaces of the electrode film 104a-b, respectively. The non-current collector 106a-b, for example, may comprise a separator, an insulator (e.g., for insulating the electrode film 104a-b, such as for use in a device) or other noncurrent collector material.

In an exemplary embodiment, the current collector 102 is a sheet of aluminum foil approximately 40 microns thick. It is noted, however, the current collector 102 is not limited to any particular size or configuration. In other exemplary embodiments, the thickness of the foil is between about 20 and about 100 microns; and in other, more specific embodiments, the thickness of the aluminum foil is between about 30 and about 50 microns. Still other embodiments are also contemplated. It is also noted that the current collector 102 is not limited to aluminum. Other conductive materials can be used for the current collector 102, such as, e.g., silver, copper, gold, platinum, and palladium, as well as various alloys of these and other metals.

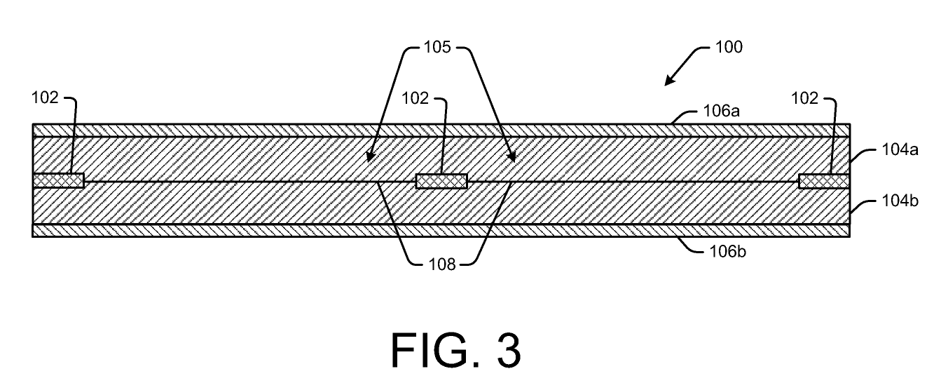

The current collector 102 is porous. That is, the current collector 102 includes a plurality of openings (e.g., openings 105 formed through the current collector 102). Accordingly, when the current collector 102 is positioned or “sandwiched” between the upper electrode film 104a and the lower electrode film 104b, an interface is formed which electrically couples the upper electrode film 104a and lower electrode film 104b, as will be described in more detail below with reference to FIG. 3.

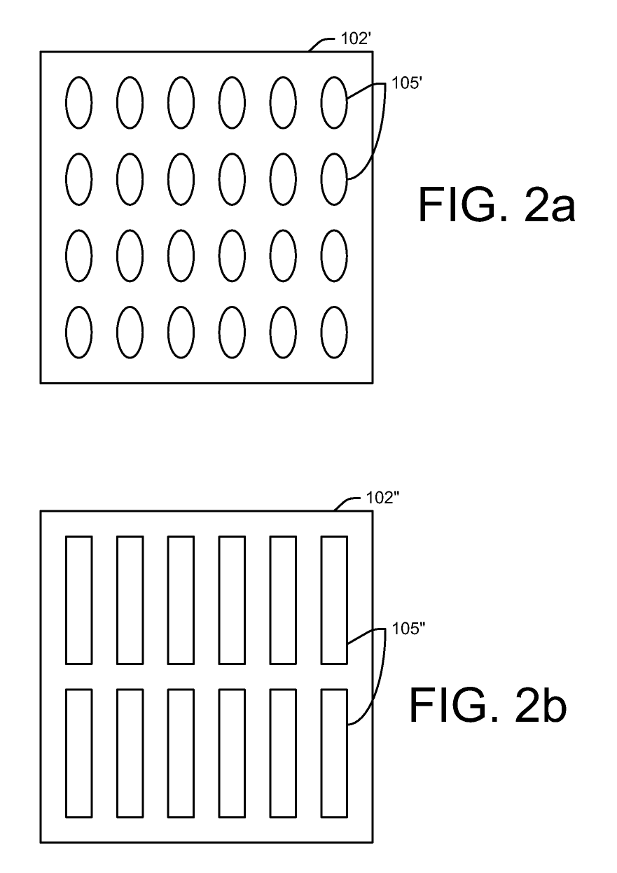

Before continuing, however, it is noted that the current collector 102 may include any number, type, and/or configuration of openings 105 formed there through. In the exemplary embodiment shown in FIG. 1, a plurality openings 105 are substantially rectangular in shape and evenly spaced across the surface of the current collector 102. FIG. 2a and 2b are top views of alternative configurations of exemplary current collectors 102′ and 102″, respectively, which may be implemented for the electrode 100. In FIG. 2a, the plurality of openings 105′ are substantially oval in shape and evenly spaced across the surface of the current collector 102′. In FIG. 2b, the plurality of openings 105″ are substantially rectangular in shape and evenly spaced across the surface of the current collector 102″. Still other sizes and shapes of openings formed through the current collector are also contemplated as being within the scope of the invention and are not limited to those shown. Likewise, the openings do not need to be evenly spaced across the surface of the current collector, as will be readily understood by those having ordinary skill in the art after becoming familiar with the teachings herein.

FIG. 3 is a side view of the exemplary electrode 100 taken along lines 3-3 in FIG. 1 showing an exemplary interface 108 that may be formed through the openings 105 of the current collector 102 between the electrode materials 104a-b. As briefly mentioned above, the interface 108 electrically couples the upper electrode film 104a and lower electrode film 104b. This interface 108 also serves to bond the electrode materials 104 to the current collector 102 at least substantially without the need for adhesives.

Before continuing, an exemplary electrode film 104 will be described in detail so that the bonding process can be better understood. The electrode film 104 may include an active electrode material (e.g., activated carbon particles) and a binder for supporting the active electrode material within the film 104. The electrode film may also optionally include conductive particles (e.g., conductive carbon particles) and/or other additives. In an exemplary embodiment, the electrode film 104 comprises activated carbon particles, conductive carbon particles, and a binder, and has a volumetric porosity surface factor (VPSF) greater than about 7.5×10⁷ m⁻¹. The electrode film 104 may also have a porosity of between about 40 and 80%. In certain more specific embodiments, the porosity of the active electrode film 104 is between about 50 and about 70 percent, and the median pore size varies between about 1 and about 3 cubic micrometers. The term “porosity” as used herein means macroporosity (i.e., porosity on a large scale defined by the interstitial volume between particles).

The electrode film 104 may be manufactured using both known and novel processes. For example, the electrode film 104 may be manufactured using an extrusion process. The polymers used in accordance with the present invention include, but are not limited to polytetraflouroethylene (PTFE or Teflon®)), polypropylene, polyethylene, co-polymers, and various polymer blends. The polymers act as a matrix for the active electrode material and within the electrode film 104.

To form the electrode film 104, powders of the polymer, the active electrode material, and possibly other powder materials are dry-blended. In one exemplary embodiment, the powders and proportions used are as follows: 85-90 percent by weight of activated carbon (the “active electrode material”), 5-8 percent by weight of PTFE, and 2-10 percent by weight of conductive carbon (graphite, acting as a promoter of electrical conduction). Suitable activated carbon powders are available from a variety of sources, including Nuchar® powders sold by Westvaco Corporation (Stamford, Conn.). Another exemplary embodiment contains 85-93 percent of activated carbon, 3-8 percent of PTFE, and 2-10 percent of conductive carbon. Yet another exemplary embodiment contains activated carbon and PTFE, and does not use conductive carbon.

In any event, the resulting compound is introduced, together with a solvent, into an extruder to fibrillate the blended material, creating a dough-like film. In one embodiment, the proportion of the powder compound to the solvent is about 80/20 by weight. The dough-like substance may be calendered one or more times to produce a desired thickness and density. Finally, the dough-like substance is baked or otherwise dried to reduce the residual solvent to an acceptable level (e.g., on the order of parts per million) to produce the electrode film 104.

Another exemplary technique for manufacturing the electrode film 104 is disclosed in a co-pending, commonly-assigned U.S. patent application Ser. No. 10/817,701, filed Apr. 2, 2004, which is incorporated herein by reference. Still other techniques, now known or later developed, may also be implemented to manufacture the electrode film 104.

Having described exemplary embodiments for producing the electrode film 104, the bonding process to current collector 102 can now be explained again with reference to FIG. 3. In an exemplary embodiment, the electrode film 104a and 104b may be bonded to the current collector 102 in a calender. That is, the current collector 102 is positioned or “sandwiched” between opposing layers of the electrode film 104a-b and fed between rollers of the calender. The calender is gap-controlled, meaning that the gap between the rollers can be set to a predetermined distance to compresses the current collector 102 and electrode film 104a-b.

In an exemplary embodiment, the thickness of each layer of electrode film 104a and 104b is between about 160 and about 180 microns, and the thickness of the current collector 102 is about 40 microns. Accordingly, the gap of the calender may be set to between about 210 to about 220 microns. Because the current collector 102 is substantially uncompressible, the calender compresses the electrode film 104a-b by about 50 percent, forcing it into the openings 105 formed through the current collector 102, and into contact with the other layer of electrode film. Coming out of the calender, the electrode film 104a-b expands, so that the more permanent reduction in its thickness is between about 5 and about 20 percent.

Note that adhesive is not applied to the surfaces of the current collector 102 or to the electrode film 104a-b, so that the interface 108 between the two surfaces is substantially free of adhesives and the impurities they may comprise. In some embodiments in accordance with the present invention, adhesion between these components results mostly from the pressure bond created by the calender. In other embodiments, however, in adhesion between these components may be due to a chemical reaction between layers of the electrode film 104a-b, and/or a combination of both mechanical interaction and chemical reaction of the layers of electrode film 104a-b.

Other processes for bonding the layers of electrode film 104a-b to one another at the interface 108 and to the current collector 102 may also be implemented in accordance with the present invention. For example, pressure-controlled calenders may be used. To improve the pressure bond, one or both of the rollers of the calendar and/or the electrode film 104a-b and/or current collector 102 may be pre-heated. The speed with which the current collector 102 and the electrode film 104a-b move through the calender 205 may also be controlled. A person having ordinary skill in the art would recognize that any of a wide variety of other design parameters may also be implemented depending on the materials used, temperatures applied, thicknesses of the electrode film 104a-b, pressure applied by the calender, desired adhesion strength, and a host of other factors.

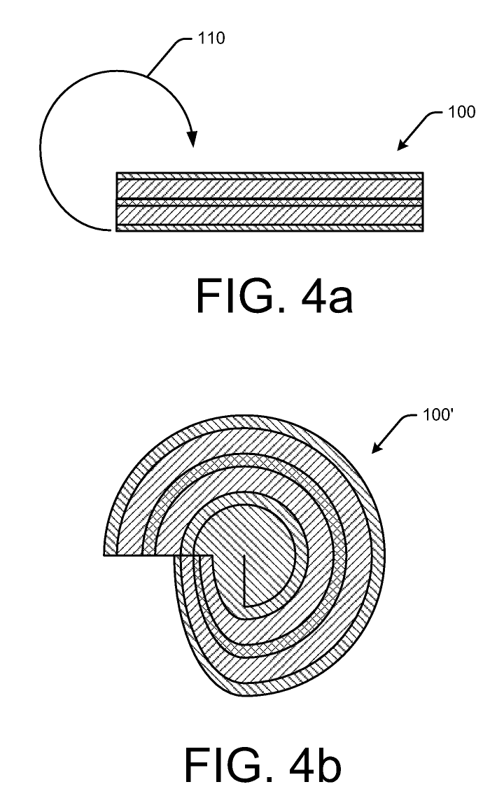

In any event, the electrode 100 may then be cut or otherwise shaped, and terminals may be attached to the current collectors to form various electrode materials and electrode devices, including but not limited to ultra-capacitors and super-capacitors. In an exemplary embodiment, the electrode 100 may be rolled into a “jelly-roll” configuration for use in various types of capacitive devices. FIG. 4a and 4b are side views illustrating a rolling process for manufacturing an exemplary electrode device from an electrode. In FIG. 4a, the electrode 100 is shown after the bonding process described above with reference to FIG. 3. The electrode 100 may then be rolled on top of itself in the direction generally illustrated by arrow 110 in FIG. 4a until it forms the “jelly-roll” configuration 100′ shown in FIG. 4b, which may then be fitted with connectors to the current collector for use as a capacitive device. The cylindrical configuration increases the amount of capacitance in a tight volume and weighs less than unrolled configurations.

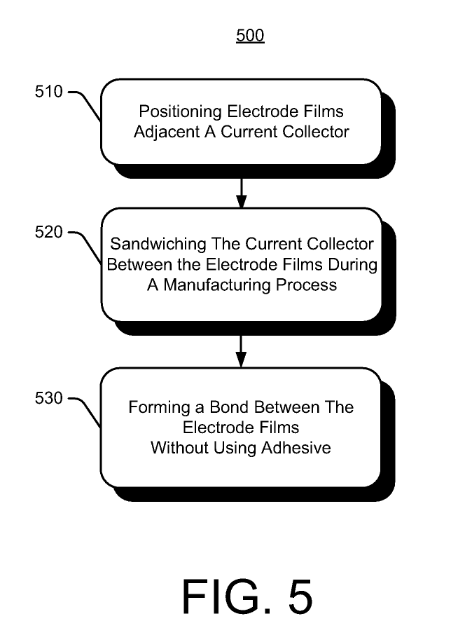

FIG. 5 is a flowchart illustrating exemplary process steps 500 for producing an exemplary electrode. In step 510, a first electrode film and a second electrode film and positioned adjacent a current collector. In step 520, the current collector is sandwiched between the first electrode film and the second electrode film during a manufacture process that may include, e.g., use of a calender as described above according to various exemplary embodiments. In step 530, a bond is formed at an interface between the first electrode film and the second electrode film through the plurality of openings formed in the current collector. It is noted that this bond secures the first electrode film and the second electrode film to the current collector without using an adhesive. Accordingly, the process steps 500 represent a completely dry electrode production process.

The inventive methods for manufacturing electrodes and electrode devices (including, but not limited to multi-layer or compound capacitors) have been described above in considerable detail. This was done for illustrative purposes. Neither the specific implementations of the invention as a whole, nor those of its features, limit the general principles underlying the invention. In particular, the invention is not necessarily limited to the specific sizes, configurations, or types of materials and proportions of constituent materials used in making the electrodes or electrode devices. The specific features described herein may be used in some implementations, but not in others, without departure from the spirit and scope of the invention as set forth. Many additional modifications are intended in the foregoing disclosure, and it will be appreciated by those of ordinary skill in the art that, in some instances, some features of the invention will be employed in the absence of other features. The illustrative examples therefore do not define the metes and bounds of the invention and the legal protection afforded the invention, which function is served by the claims and their equivalents.

1. An electrode material comprising:
a first electrode film and a second electrode film;
a current collector sandwiched between the first electrode film and the second electrode film during a manufacture process, the current collector having a plurality of openings formed there through; and
a bond formed at an interface between the first electrode film and the second electrode film through the plurality of openings formed in the current collector after the manufacture process, the bond securing the first electrode film and the second electrode film to the current collector substantially without using an adhesive.

2. The electrode material of claim 1 wherein the bond securing the first electrode film and the second electrode film to the current collector is provided without using an adhesive

3. The electrode material of claim 1 wherein the manufacture process includes applying pressure collectively to the first electrode film, the second electrode film, and the current collector.

4. The electrode material of claim 1 wherein the manufacture process includes applying heat.

5. The electrode material of claim 1 further comprising a non-conductive separator overlayed on at least one of the electrode materials.

6. The electrode material of claim 1 wherein the manufacture process produces a compound capacitor.

7. The electrode material of claim 6 wherein the compound capacitor is an ultra-capacitor or a super-capacitor.

8. The electrode material of claim 1 wherein the manufacture process results in a mechanical meshing of the first electrode film and the second electrode film at the interface.

9. A method for producing an electrode material comprising:
positioning a current collector between a first electrode film and a second electrode film; and
coupling the first electrode film and the second electrode film through a plurality of openings formed in the current collector to secure the first electrode film and the second electrode film to the current collector substantially without using an adhesive.

10. The method of claim 9 wherein the operation of coupling the first electrode film and the second electrode film is performed without using an adhesive.

11. The method of claim 9 further each step is a dry step.

12. The method of claim 9 further comprising electrically coupling the first electrode film and the second electrode film to one another.

13. The method of claim 9 further comprising applying heat to enhance a bond between the first electrode film and the second electrode film.

14. The method of claim 9 further comprising positioning a non-conductive separator to at least one of the electrode materials.

15. The method of claim 9 further comprising mechanically meshing the first electrode film and the second electrode film together through the plurality of openings formed in the current collector.

16. The method of claim 9 wherein coupling the first electrode film and the second electrode film is at least in part by a chemical reaction between the first electrode film and the second electrode film.

17. The method of claim 9 wherein coupling the first electrode film and the second electrode film is by a mechanical interaction and a chemical reaction between the first electrode film and the second electrode film.

18. The method of claim 9 further comprising rolling the first electrode film, second electrode film, and current collector onto itself.

19. A compound capacitor produced according to the method of claim 9.

20. A compound capacitor device comprising:
a porous current collector sandwiched between two electrode materials; and
an interface coupling the two electrode materials to one another and to the porous current collector substantially without an adhesive.

21. The compound capacitor of claim 20 wherein the interface couples the two electrode materials to one another and the porous current collector without adhesive.

22. The compound capacitor device of claim 20 wherein the two electrode materials are mechanically bonded to each other through the porous current collector.

23. The compound capacitor device of claim 20 wherein the two electrode materials are chemically bonded to each other through the porous current collector.

24. The compound capacitor device of claim 20 wherein the two electrode materials comprise electrode films.
